(19) United States
(12) Patent Application Publication
(10) Pub. No.: US 2019/0145570 A1
(43) Pub. Date: May 16, 2019

(54) CORROSION-RESISTANT PIPING AND METHODS OF MANUFACTURING AND USING THE SAME

(71) Applicant: Saudi Arabian Oil Company, Dhahran (SA)

(72) Inventors: Sayee Prasad Raghunathan, Dhahran (SA); Abdullah M. Al-Rumaih, Khobar (SA); Hendrik Debruyn, Bjoerkelangen (NO)

(21) Appl. No.: 15/814,694

(22) Filed: Nov. 16, 2017

(51) Int. Cl. F16L 58/08; C21D 9/08; C21D 9/50; F16L 58/18; B23K 9/028; B23K 20/00; F16L 13/02

(52) U.S. Cl. CPC F16L 58/08; C21D 9/08; C21D 9/50; C21D 2211/001; B23K 9/0282; B23K 20/00; F16L 13/0263; F16L 58/181

(57) ABSTRACT

Described in the present disclosure is corrosion-resistant piping (for example, for transportation of oil, natural gas, petrochemicals, water, wastewater, utilities, or the like) and low-cost methods for manufacturing and using the same. In certain embodiments, a corrosion-resistant cladding sparingly disposed specifically on and near the weld joint(s) of the piping provides an improved resistance to microbiologically induced corrosion. The targeted cladding prevents or reduces chemical and physical changes to the surface of the piping in the heat-affected zone near each weld joint. Without wishing to be bound to any particular theory, it is thought that the cladding prevents or reduces bacterial adhesion and subsequent MIC. In certain embodiments, the corrosion-resistant cladding described in the present disclosure may be manufactured at a significantly decreased cost compared to that of clad piping. The present disclosure provides various configurations of corrosion-resistant piping and methods for manufacturing and using the same.

### FIELD

The present disclosure relates generally to corrosion-resistant piping (for example, for oil transportation, gas transportation, petrochemical transportation, or the like) and methods for manufacturing and using the same.

### BACKGROUND

Stainless steel piping is used in a variety of industries because of its resistance to some types of corrosion. In particular, piping constructed from austenitic stainless steel (for example, 300 series stainless steel such as alloy 304, alloy 316, alloy 321, alloy 347, and their low and high carbon grade variants) is used for the transport of fluids in the oil and gas industry, in pulp and paper plants, in wastewater treatment plants, in power generation plants, in metalworking plants, and in the chemical and petrochemical industries. Austenitic stainless steel piping is also used in utility piping systems such as for the transport of steam, water, compressed air, and the like. Nevertheless, austenitic stainless steel piping is still susceptible to corrosion under common operating conditions and is particularly susceptible to microbiologically induced corrosion (MIC), a localized corrosion process caused by microorganisms that are adhered to internal surfaces of piping. There is a need for piping with an improved resistance to corrosion, and, more particularly, with an improved resistance to localized adhesion and MIC.

### SUMMARY

Described in the present disclosure is corrosion-resistant piping (for example, for transportation of oil, natural gas, petrochemicals, water, wastewater, utilities, or the like) and low-cost methods for manufacturing and using the same. In certain embodiments, a corrosion-resistant cladding sparingly disposed specifically on and near the weld joint(s) of the piping provides an improved resistance to microbiologically induced corrosion. The targeted cladding prevents or reduces chemical and physical changes to the surface of the piping in the heat-affected zone near each weld joint. Without wishing to be bound to any particular theory, it is thought that the cladding prevents or reduces bacterial adhesion and subsequent MIC. In certain embodiments, the corrosion-resistant cladding described in the present disclosure may be manufactured at a significantly decreased cost compared to that of clad piping. The present disclosure provides various configurations of corrosion-resistant piping and methods for manufacturing and using the same.

In one aspect, the present disclosure is directed to corrosion-resistant (e.g., microbiologically induced corrosion-resistant) piping [e.g., a corrosion-resistant pipeline e.g., for transportation of oil, natural gas, petrochemicals, water, wastewater, utilities, or the like] comprising two or more segments of pipe, each of said segments having a composition comprising a stainless steel alloy [e.g., austenitic stainless steel (e.g., stainless steel 304/304L, 316/316L, 321/347), or equivalent], wherein: (i) the piping comprises one or more weld joints at which one segment of pipe is joined to another [e.g., by a girth (e.g., circumferential) weld]; (ii) at least one of the one or more weld joints has disposed thereon a corrosion-resistant cladding, the corrosion-resistant cladding comprising at least one layer having a composition comprising a corrosion-resistant alloy [e.g., a heat-treatable Ni alloy (e.g. an alloy with a Ni percentage of greater than 40 wt. %, e.g., alloy 625) or super austenitic stainless steel (e.g., 254SMo/S31254)] (e.g., wherein a corrosion resistance of the corrosion-resistant alloy is greater than a corrosion resistance of the stainless steel alloy of said segments of pipe); and (iii) for each of the one or more weld joints, the corrosion-resistant cladding extends in length along an internal surface area portion of each of the joined segments of pipe adjacent to the weld joint from an outermost edge of the weld joint to at least a corrosion-susceptible length of pipe, wherein said corrosion-susceptible length of pipe is from 10 mm to 100 mm (e.g., from 10 mm to 50 mm) and less than a full length of a corresponding segment of pipe.

In certain embodiments, the stainless steel alloy is austenitic stainless steel or super austenitic stainless steel (e.g., alloy 304/304L, e.g., alloy 316/316L, e.g., alloy 321/347, e.g., alloy 254SMo/S31254).

In certain embodiments, the corrosion-resistant cladding comprises one to three layers having a composition comprising the corrosion-resistant alloy.

In certain embodiments, the corrosion-resistant cladding is 1 mm to 3.5 mm in thickness.

In certain embodiments, the corrosion-resistant alloy is a Ni alloy [e.g., alloy 625, e.g., alloy 825, e.g., wherein the Ni alloy has a percentage of Ni by weight (based on the total weight of the corrosion-resistant alloy) of 40% or greater] or super austenitic stainless steel (e.g., alloy 254SMo/S31254).

In certain embodiments, one segment of pipe is joined to another [e.g., by a girth (e.g., circumferential) weld] with a weld material [e.g., wherein a composition of the weld material is a Ni alloy with a percentage of Ni by weight of 40% or greater (based on the total weight of the weld material), e.g., alloy 625, e.g., alloy 825].

In certain embodiments, the internal surface area portion of each of the joined pipe segments comprises a machined recess (e.g., corresponding to a location of the corrosion-resistant cladding) (e.g., to reduce transitions in the internal diameter (ID) of the corrosion-resistant piping near each weld joint, e.g., to comply with design codes, e.g. ASME B31.3, e.g. ASME B31.4, e.g. ASME B31.8) (e.g., with a depth of at least 1 mm, e.g., with a depth in a range of 1 mm to at least 3 mm).

In certain embodiments, a surface of the corrosion-resistant cladding is machined (e.g., to reduce transitions in the internal diameter (ID) of the corrosion-resistant piping near each weld joint, e.g., to comply with design codes, e.g. ASME B31.3, e.g. ASME B31.4, e.g. ASME B31.8).

In certain embodiments, the corrosion-resistant piping further comprises at least one fitting (e.g. an elbow, a reducer, a tee, a valve, a flange, a bend, or the like).

In certain embodiments, the corrosion-resistant alloy is heat treatable (e.g., heat treatable via methods such as solution annealing).

In one aspect, the present disclosure is directed to a method for manufacturing corrosion-resistant (e.g., microbiologically induced corrosion-resistant) piping [e.g., a corrosion-resistant pipeline e.g., for transportation of oil, natural gas, petrochemicals, water, wastewater, utilities, or the like] comprising two or more segments of pipe, each of said segments having a composition comprising a stainless steel alloy [e.g., austenitic stainless steel (e.g., stainless steel 304/304L, 316/316L, 321/347), or equivalent], the method comprising: applying a corrosion-resistant cladding to two or more segments of pipe, each of said segments having a composition comprising a stainless steel alloy [e.g., austenitic stainless steel (e.g., stainless steel 304/304L, 316/316L, 321/347), or equivalent], wherein (i) the corrosion-resistant cladding comprises at least one layer having a composition comprising a corrosion-resistant alloy [e.g., a heat-treatable Ni alloy (e.g. an alloy with a Ni percentage of greater than 40 wt. %, e.g., alloy 625) or super austenitic stainless steel (e.g., 254SMo/S31254)] (e.g., wherein a corrosion resistance of the corrosion-resistant alloy is greater than a corrosion resistance of the stainless steel alloy of said segments of pipe), (ii) the corrosion-resistant cladding extends in length along an internal surface area portion of each of the segments of pipe adjacent to an end of each segment from an outermost edge of the end to at least a corrosion-susceptible length of pipe, wherein said corrosion-susceptible length of pipe is from 10 mm to 100 mm (e.g., from 10 mm to 50 mm) and less than a full length of a corresponding segment of pipe; and joining the two or more segments of pipe using a weld material [e.g., wherein the weld material has a composition comprising a Ni alloy with a percentage of Ni by weight of 40% or greater (based on the total weight of the weld material), e.g., alloy 625, e.g., alloy 825], wherein at least one outermost edge of an end of each of the two or more segments of pipe is joined [e.g., by a girth (e.g., circumferential) weld] to an outermost edge of an end of an adjacent segment of pipe, thereby forming a weld joint.

In certain embodiments, the two or more segments of pipe are not solution annealed prior to the step of applying a cladding (e.g., the two or more segments of pipe are not “solution annealed” at about 1040° C. and quenched per ASTM/ASME product standards before applying the corrosion-resistant cladding).

In certain embodiments the method comprises, after applying the corrosion-resistant cladding, heating (e.g., annealing) the two or more segments of pipe (e.g., according to ASTM/ASME product standards, e.g., at a temperature of approximately 1040° C. or greater); and rapidly cooling (e.g., quenching, e.g., cooling at a rate sufficient to prevent reprecipitation of carbides and/or other undesirable byproducts in the stainless steel alloy, e.g., as per ASTM/ASME product standards) the two or more segments of pipe in a fluid [e.g., water (e.g., with or without salts and/or chemical additives), e.g., air).

In certain embodiments, the stainless steel alloy is austenitic stainless steel or super austenitic stainless steel (e.g., alloy 304/304L, e.g., alloy 316/316L, e.g., alloy 321/347, e.g., alloy 254SMo/S31254).

In certain embodiments, the composition of the corrosion-resistant cladding comprises one to three layers having a composition comprising the corrosion-resistant alloy.

In certain embodiments, the corrosion-resistant cladding is 1 mm to 3.5 mm in thickness.

In certain embodiments, the corrosion-resistant alloy is a Ni alloy [e.g., alloy 625, e.g., alloy 825, e.g., wherein the Ni alloy has a percentage of Ni by weight (based on the total weight of the corrosion-resistant alloy) of 40% or greater] or super austenitic stainless steel (e.g., alloy 254SMo/S31254).

In certain embodiments, the corrosion-susceptible length of pipe is in a range from 10 mm to 50 mm.

In certain embodiments, the method comprises, prior to applying the corrosion-resistant cladding: machining a recess in the internal surface area portion of each segment of pipe (e.g., in the internal surface area portion of the pipe corresponding to the location of the corrosion-resistant cladding) (e.g., wherein the a depth of the recess is at least 1 mm, e.g., wherein a depth of the recess is in a range from 1 mm to at least 3 mm); and applying the corrosion-resistant cladding to one or more of the machined recesses.

In certain embodiments, the step of applying the corrosion-resistant cladding is performed before the two or more segments of pipe are manufactured (e.g., when each segment of pipe is in the “plate stage”, e.g., before each segment of pipe is rolled).

In certain embodiments, the step of applying the corrosion-resistant cladding is performed after the two or more segments of pipe are manufactured [e.g., using an arc surfacing/overlaying technology (e.g., plasma surfacing), e.g., using a cladding technology (e.g., hot roll bonding, e.g., explosion bonding)].

In certain embodiments, the method comprises, following applying the corrosion-resistant alloy, machining a surface of the corrosion-resistant cladding (e.g., to reduce transitions in the internal diameter (ID) of the corrosion-resistant piping near each weld joint, e.g., to comply with design codes, e.g. ASME B31.3, e.g. ASME B31.4, e.g. ASME B31.8).

In certain embodiments, at least one of the two or more segments of pipe is a fitting (e.g. an elbow, e.g., a reducer, e.g., a tee, e.g., a valve, e.g. a flange, e.g. a bend).

In certain embodiments, the corrosion-resistant alloy is heat treatable (e.g., heat treatable via methods such as annealing).

In one aspect, the present disclosure is directed to a method of using the corrosion-resistant (e.g., microbiologically induced corrosion-resistant) piping of any one of the preceding claims, the method comprising conducting a fluid (e.g., water, e.g., gas, e.g., a petrochemical, e.g., wastewater, e.g., a fluid comprising H₂S and CO₂) through the two or more segments of pipe for at least one month (e.g., 2 months, 3 months, 6 months, 1 year, 2 years, or longer).

In certain embodiments, following the at least one month (e.g., 2 months, 3 months, 6 months, 1 year, 2 years, or longer), the corrosion-resistant piping satisfies criteria set forth by the American Welding Society (AWS) in AWS D18.1/D18.1M:2009.

In certain embodiments, following the at least one month (e.g., 2 months, 3 months, 6 months, 1 year, 2 years, or longer), a color of a surface oxide (e.g. chromium oxide) (e.g., oxide layer associated with heat tint) on a surface of the corrosion-resistant cladding satisfies criteria set forth by the American Welding Society in AWS D18.2:1999.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1A is a diagram showing two segments of pipe prior to being joined at a weld joint, according to an illustrative embodiment.

FIG. 1B is a diagram showing two segments of pipe after being joined at a weld joint, according to an illustrative embodiment.

FIG. 2A is a diagram showing two segments of pipe joined at a weld joint with a corrosion-resistant cladding disposed on the weld joint, according to an illustrative embodiment.

FIG. 2B is a diagram showing two segments of pipe joined at a weld joint with a corrosion-resistant cladding disposed on the weld joint, wherein an internal surface area portion of each of the segments of pipe includes a machined recess, according to an illustrative embodiment.

FIG. 3 is a block flow diagram of a method for manufacturing corrosion-resistant piping, according to an illustrative embodiment.

FIG. 4 is a diagram of corrosion resistant piping, according to an illustrative embodiment.

The features and advantages of the piping and methods described in the present disclosure will become more apparent from the detailed description set forth below when taken in conjunction with the drawings, in which like reference characters identify corresponding elements throughout. In the drawings, like reference numbers generally indicate identical elements, functionally similar elements, structurally similar elements, or combinations of the three.

### Definitions

About, Approximately: As used in this application, the terms “about” and “approximately” are used as equivalents. Any numerals used in this application with or without about/approximately are meant to cover any normal fluctuations appreciated by one of ordinary skill in the relevant art. In certain embodiments, the term “approximately” or “about” refers to a range of values that fall within 20%, 10%, 5%, or 1% or less in either direction (greater than or less than) of the stated reference value unless otherwise stated or otherwise evident from the context (except where such number would exceed 100% of a possible value).

Annealing: As used in the present disclosure, the term “annealing” means heating a material to improve its properties, for example, to improve its strength, corrosion, resistance, or the like. During annealing, an alloy may be heated to a minimum temperature (for example, of 1040° C.) to dissolve carbon species within the alloy. For example, annealing may be performed as per relevant ASTM/ASME product standards.

Austenitic stainless steel: As used in the present disclosure, the term “austenitic stainless steel” refers to a specific alloy of stainless steel containing austenite (that is, gamma phase iron with a face-centered cubic crystal structure) as its primary phase crystal structure. Examples of austenitic stainless steel include the 300 series of stainless steel.

Base metal: As used in the present disclosure, the term “base metal” means the metal material to be joined by welding. For example, the base metal of a segment of pipe may have a composition that includes a stainless steel alloy.

Corrosion-resistant cladding: As used in the present disclosure, the term “corrosion-resistant cladding” refers to a thin (greater than about 1 mm) layer of material applied to a base metal to improve corrosion resistance. In some embodiments, a corrosion-resistant cladding may include a corrosion-resistant material that is disposed on a surface of a less corrosion-resistant material. For example, the corrosion-resistant material may have a composition that includes a corrosion-resistant alloy. For example, a stainless steel or nickel-based corrosion-resistant cladding may be disposed on a base metal. For example, “corrosion-resistant cladding” may refer to corrosion-resistant material disposed on a base metal via a metallurgical bond. For example, “corrosion-resistant cladding” may refer to a corrosion-resistant material disposed on a base metal via solid state or mechanical bonding. In some embodiments, a corrosion-resistant cladding is selected based on the shape of the segment of pipe (for example, plate, sheet, pipe, or the like), the properties of the corrosion-resistant material (for example, whether it can tolerate high temperatures), and the properties of the base metal (for example, whether it can tolerate high temperatures).

Corrosion: As used in the present disclosure, the term “corrosion” refers to a chemical process in which a metal or alloy is converted to an alternative form. For example, a base metal or alloy may be converted to alternative chemical form (for example, an oxide, a hydroxide, or a sulfide) by corrosion. For example, rusting is a forming of corrosion. In some embodiments, corrosion may occur in localized areas and result in the formation of pits, cracks, or both.

Corrosion-susceptible length: As used in the present disclosure, the term “corrosion-susceptible length” may refer to an approximate length from an outermost edge of a weld joint of a segment of pipe to, for example, the outermost extent of a heat affected zone in the segment of pipe. For example, a corrosion-susceptible length may refer to a length of pipe near a weld joint that has increased susceptibility to corrosion (for example, MIC) after welding. In some embodiments, a corrosion susceptible length may be in a range from 10 mm to 100 mm and less than a full length of the corresponding segment of pipe. In some embodiments, a corrosion susceptible length may be in a range from 10 mm to 50 mm and less than a full length of the corresponding segment of pipe.

Fitting: As used in the present disclosure, the term “fitting” refers to a piping component other than a segment of straight pipe. For example, a fittings may be an elbow, a reducer, a tee, a valve, a flange, a bend, or the like.

Heat affected zone: As used in the present disclosure, the term “heat affected zone” refers to a portion of the segment of pipe that has altered physical (for example, microstructural) properties, chemical properties, or both following welding or other high-temperature processing (for example, applying a cladding or weld overlay). For example, the physical appearance (for example, color) of a segment of pipe may be different in the heat affected zone than elsewhere along the internal surface of a segment of pipe.

Clad piping: As used in the present disclosure, the term “clad piping” refers to piping that includes a cladding that extends along the entire length of the piping. For example, each segment of pipe in clad piping includes a cladding that extends from an outermost edge of each weld joint to the entire length of the corresponding segment of pipe.

Heat tint: As used in the present disclosure, the term “heat tint” refers to the color of a surface oxide (for example, in the heat affected zone) that is formed by welding or other high-temperature processing (for example, applying a cladding or weld overlay). The heat tint is related to the thickness and chemical properties of an oxidized layer (for example, of chromium oxide) formed on a surface during, for example, welding at a high temperature.

Heat treatable: As used in the present disclosure, the term “heat treatable” refers to the property of being modifiable via processing at high temperature. For example, certain alloys are heat treatable. For example, heat treatable alloys may be “heat treated” to reduce compositional gradients in alloys, to improve the strength of an alloy, to relieve stress in an alloy, or the like. For example, Alloy 625 may be heat treated at about 1038° C. and rapidly cooled to improve the strength of the material. It should be understood that the approaches described in the present disclosure may also employ other heat treatable materials and methods of heat treatment.

Hydrostatic testing: As used in the present disclosure, the term “hydrostatic testing” refers to a method of evaluating the strength of and leaks from pressurized piping. In some embodiments, hydrostatic testing includes filling the piping with a fluid, for example, water to a specified pressure. For example, the piping may then be visually inspected to assess the presence or absence of leaks, loss of pressure over time, or both.

Improve, Increase, reduce, decrease: As used in the present disclosure, the terms “improve”, “increase”, “reduce, “decrease”, or their grammatical equivalents, indicate values that are relative to a baseline or other reference measurement.

Parts per million: As used in the present disclosure, the term “parts per million” (ppm) refers to a measure of one part of a solute (for example, a salt) per 1 million parts of a solvent (for example, water). For example, 1 ppm may correspond to a concentration of 1 milligram (mg) of a salt in 1 kilogram (kg) of water. In some embodiments, parts per million may refer to a mass of a solute (for example, a salt) in a volume of a solvent (for example, water). For example, 1 ppm may correspond to a concentration of 1 milligram (mg) of a salt in 1 liter (L) of water.

Passivation: As used in the present disclosure, the term “passivation” refers to the formation of a protective layer on the surface of a metal or alloy (for example, a stainless steel alloy or a corrosion-resistant alloy) that improves the corrosion resistance of the metal or alloy. For example, the protective layer may be rich in Ni and Cr. In some embodiments, a surface is less prone to oxidation, corrosion, or the like after passivation.

Pickling: As used in the present disclosure, the term “pickling” refers to a surface treatment used to remove impurities such as stains, inorganic contaminants, rust, scale, or the like from the surface of a metal or alloy (for example, a stainless steel alloy or a corrosion-resistant alloy).

Piping: As used in the present disclosure, the term “piping” means a system of pipes used to convey fluids (for example, liquids, gases, or both) from one location to another. In some embodiments, piping may refer to a pipeline or other equipment for oil transportation, gas transportation, petrochemical transportation, utility systems, or the like. In some embodiments, piping may refer to a system of pipes used for process operations, for example, in the pulp and paper industry, in wastewater treatment plants, in power generation plants, in metalworking plants, in chemical plants, or petrochemical plants.

Quenching: As used in the present disclosure, the term “quenching” means a process of cooling a metal at a rapid rate. For example, during quenching an alloy may be rapidly cooled at a rate that is sufficient to prevent the precipitation of carbides dissolved during a previous annealing (or heat treatment) step. For example, quenching of a heated alloy may be performed as per relevant ASTM/ASME product standards. For example, quenching may be performed in water with or without the addition of salts or other additives. For example, quenching may be performed using an air blast, or a stream of air with a high velocity. For example, quenching may be performed in still air.

Segment of pipe: As used in the present disclosure, the term “segment of pipe” refers to a single component of a system of pipes. For example, piping may comprise two or more segments of pipe. As used in the present disclosure, the term “segment of pipe” generally refers to a straight segment of pipe. In some embodiments, a segment of pipe may be a fitting such as an elbow, a reducer, a tee, a valve, a flange, a bend, or the like.

Solution annealing: As used in the present disclosure, the term “solution annealing” refers to a process that includes annealing and quenching to, for example, improve the corrosion resistance or other properties of an alloy. For example, during solution annealing, a stainless steel alloy may be heated to (or annealed at) a sufficiently high temperature to dissolve carbides in a stainless steel alloy and rapidly cooled (or quenched) at a rate that is sufficient to prevent the reprecipitation of the dissolved carbides. In some embodiments, solution annealing may improve the corrosion resistance of a stainless steel alloy, a corrosion-resistant alloy, or both.

Super austenitic stainless steel: As used in the present disclosure, the term “super austenitic stainless steel” refers to an austenitic stainless steel alloy with a high molybdenum content (greater than 6 weight percent) and nitrogen additions. For example, a super austenitic stainless steel may be AL-6XN or 254SMO/S31254. In some embodiments, a super austenitic stainless steel alloy has a superior corrosion resistance and higher cost than those of a similar austenitic stainless steel alloy.

Weld joint: As used in the present disclosure, the term “weld joint” refers to a point or edge at which two or more pieces of metal are joined together, for example, using a weld material.

Weld overlay: As used in the present disclosure, the term “weld overlay” refers to a type of cladding in which an alloy is welded onto the surface of a base metal. For example, a corrosion-resistant alloy may be welded onto an internal surface area portion of a segment of pipe, thereby forming a weld overlay. For example, a weld overlay may be applied using an arc surfacing or overlaying technology such as plasma surfacing.

### DETAILED DESCRIPTION

It is contemplated that systems and methods claimed in the present disclosure encompass variations and adaptations developed using information from the embodiments described in the present disclosure. Adaptation, modification, or both of the systems and methods described in the present disclosure may be performed, as contemplated by this description.

Throughout the description, where articles, devices, systems, and architectures are described as having, including, or comprising specific components, or where processes and methods are described as having, including, or comprising specific steps, it is contemplated that, additionally, there are articles, devices, systems, and architectures of the present invention that consist essentially of, or consist of, the recited components, and that there are processes and methods according to the present invention that consist essentially of, or consist of, the recited processing steps. As used in the present disclosure, the term “comprise” and variations of the term, such as “comprising” and “comprises,” are not intended to exclude other additives, components, integers, or steps.

It should be understood that the order of steps or order for performing certain action is immaterial so long as the invention remains operable. Moreover, two or more steps or actions may be conducted simultaneously.

The mention in the present disclosure of any publication, for example, in the Background section, is not an admission that the publication serves as prior art with respect to any of the claims presented herein. The Background section is presented for purposes of clarity and is not meant as a description of prior art with respect to any claim.

Documents are incorporated in the present disclosure by reference as noted. Where there is any discrepancy in the meaning of a particular term, the meaning provided in the Definition section above is controlling.

Headers are provided for the convenience of the reader—the presence, placement, or both of a header is not intended to limit the scope of the subject matter described in the present disclosure.

The present disclosure encompasses the recognition that improved corrosion resistance may be efficiently and effectively provided for a pipeline by applying an MIC-resistant cladding on an internal surface area portion of each pipe segment corresponding to a corrosion susceptible length of the segment. For example, in some embodiments, improved corrosion resistance may only be required in the heat affected zone near each weld joint because these surface area portions are particularly susceptible to microbiologically induced corrosion (MIC). In certain embodiments, a corrosion-resistant cladding may protect the underlying stainless steel alloy, or base metal, of a segment of pipe. For example, a corrosion-resistant cladding may prevent (or significantly reduce) changes to the physical properties (for example, microstructure), chemical composition, or both on a surface area portion that extends at least a corrosion-susceptible length of pipe. Accordingly, in some embodiments, the corrosion-resistant cladding described in the present disclosure may decrease the corrosion-resistant piping's susceptibility to MIC, other forms of corrosion, or both. In some embodiments, corrosion-resistant cladding(s) disposed on weld joint(s) of the corrosion-resistant piping may prevent the formation of a biofilm near the weld joint(s).

It should be understood that the corrosion-resistant piping described in the present disclosure may be manufactured at a lower cost than conventional clad piping. For example, the corrosion-resistant cladding, as described in the present disclosure, may extend from an outermost edge of each weld joint to at least a corrosion susceptible length and less than a full length of a corresponding segment of pipe. In some embodiments, the corrosion susceptible length of pipe may be in a range from 10 mm to 50 mm. For example, a 6-meter segment of pipe with a 50 mm cladding at each end has a corrosion-resistant cladding on less than 2% of its internal surface area. Accordingly, the cost associated with the corrosion-resistant alloy used in this example corrosion-resistant piping would be about 2% or less than the cost of a similar length of conventional clad piping.

Moreover, the present disclosure also encompasses the recognition that the corrosion resistance of piping may be improved (for example, in the heat affected zone) after a corrosion-resistant cladding is applied by performing a post-cladding solution annealing step. In some embodiments, a post-cladding solution annealing step may include, after applying a corrosion-resistant cladding, heat treating and rapidly cooling each segment of pipe. In some embodiments, each segment of pipe is not solution annealed before the cladding is applied and before the post-cladding solution annealing step is performed. Without wishing to be bound to any particular theory, it is thought that solution annealing a segment of pipe after the cladding is applied improves the chemical and physical properties of the base metal near each cladding, resulting in improved corrosion resistance.

It should be understood that—while the corrosion-resistant piping and associated methods are primarily described in the present disclosure with respect to their use for the transportation of oil, gas, petrochemicals, and the like—the approaches described in the present disclosure may also be used for other applications and in other industries, for example, where MIC may be an issue. For example, these approaches may be used in piping for process operations in the pulp and paper industry, wastewater treatment plants, power generation plants, metalworking plants, chemical plants, petrochemical plants, or the like.

### Austenitic Stainless Steel

Austenitic stainless steel may be prepared by solution annealing a stainless steel alloy. During solution annealing, a segment of pipe with a composition that includes a stainless steel alloy is heated to a critical temperature at which carbon species (for example, carbides) in the stainless steel alloy dissolve and is subsequently rapidly cooled to prevent the dissolved carbon species from reprecipitating and forming an undesirable carbide phase. The austenitic stainless steel alloy may have an improved corrosion resistance than that of the original stainless steel alloy.

However, austenitic stainless steel piping remains susceptible to localized corrosion under common operating conditions. For example, guidance provided in international standard NACE MR0175/ISO 15156, Part 3 (Table A.2) indicates that 300 series austenitic stainless steel should not be used under a range of environmental conditions. For example, NACE MR0175/ISO 15156 suggests that piping constructed from alloy 316L should only be used at temperatures of less than 60° C., H₂S partial pressure of less than 145 pounds per square inch (psi), chloride concentrations of less than 50,000 ppm, and pH levels of greater than 4.5.

For the transport of highly corrosive fluids (for example, fluids with high concentrations of H₂S and CO₂ or fluids transported at high flow rates), piping may be constructed from an alloy that is more corrosion resistant than austenitic stainless steel. International standards provide guidance for selecting such materials. For example, NACE MR0175/ISO 15156, Part 3 provides guidance for selecting corrosion-resistant alloys for use in piping for gas production and natural gas treatment plants. Although piping constructed from corrosion-resistant alloys may be less prone to failures caused by corrosion, the high cost of corrosion-resistant alloys prohibits their use in most applications.

For some applications, clad piping—in which a layer of a corrosion-resistant alloy is applied on the entire internal surface of the piping—may be used as instead of piping constructed entirely from a corrosion-resistant material. Clad piping may cost less than piping with a similar length that is constructed entirely from a corrosion-resistant alloy. However, clad piping is still prohibitively expensive for many applications. For example, upgrading over 3.2 km of stainless steel piping to clad piping containing alloy 825 may cost greater than $100 million. For example, upgrading stainless steel piping in a gas compression system to clad piping containing alloy 625/825 may cost greater than $400 million.

Accordingly, the use of conventional clad piping is often not economically feasible for use in industry. The corrosion-resistant piping described in the present disclosure be a lower cost alternative to clad piping, while providing an equivalent or superior corrosion resistance.

### Microbiologically Induced Corrosion

Microbiologically induced corrosion (MIC) is a corrosion process in which microorganisms (for example, bacteria such as sulfate-reducing bacteria, archaea, fungi, or the like) form biofilms the surface of a metal or alloy, resulting in locally acidic environments which accelerate corrosion of the surface. For example, MIC may affect piping used in power plants, chemical plants, oil and gas transportation pipelines, potable water pipelines, and the like.

MIC can occur in stainless steel piping that has been exposed to water at any point in its life cycle. For example, even piping that does not encounter water during normal operation may be exposed to water (and the microorganisms it contains) during hydrostatic testing (for example, at the project testing stage). Microorganisms from the water may adhere to the piping and remain dormant until a biofilm forms under suitable conditions (for example, at a low flow rate or appropriate fluid composition).

Once formed inside piping, biofilms may cause complex changes to the physical and chemical properties of the surrounding fluid and the surface of the piping near the biofilm, often leading to MIC. However, MIC may not begin immediately after a biofilm is established. Instead, bacteria in a biofilm may first adjust to the biofilm's environment during a “lag phase” before the biofilm grows more rapidly in a “growth phase.” The environmental conditions in the piping may determine the total time required for the lag and growth phases. For example, a biofilm may require about one week to become established in raw seawater which contains a high concentration of organic material. In contrast, the same process may take more than a month in filtered seawater which contains significantly less organic material. However, once a mature biofilm is established, MIC may occur.

MIC has caused unexpected and rapid failure in otherwise corrosion-resistant materials even under mild conditions. Major failures have occurred in newly constructed piping projects as a result of MIC. Such failures may result in major delays to the start-up of pipeline projects, and extensive efforts may be required to inspect and detect each segment of pipe that is affected by MIC to repair or replace damaged segments. Even after such corrective efforts are performed, piping may still fail prematurely because of MIC.

Current methods to control or prevent biofilm formation have a limited effectiveness, and MIC is difficult to prevent using conventional strategies. For example, established biofilms may be difficult to remove because biofilms are resistant to most biocides. Moreover, the effectiveness of a given biocide at removing a biofilm may decrease as the biofilm's thickness increases. For example, even if all the bacteria in a biofilm are killed, the remaining biofilm components may still cause increased rates of localized corrosion. Exposure of piping to microorganisms (for example, during hydrostatic testing) may be limited to some extent by controlling the quality of water used in these tests (for example, the concentration of organic material in the water). However, such approaches may have a limited effectiveness because water quality criteria may be difficult to maintain in common settings, for example, where the quality of available water may be variable and other environmental factors are difficult to control.

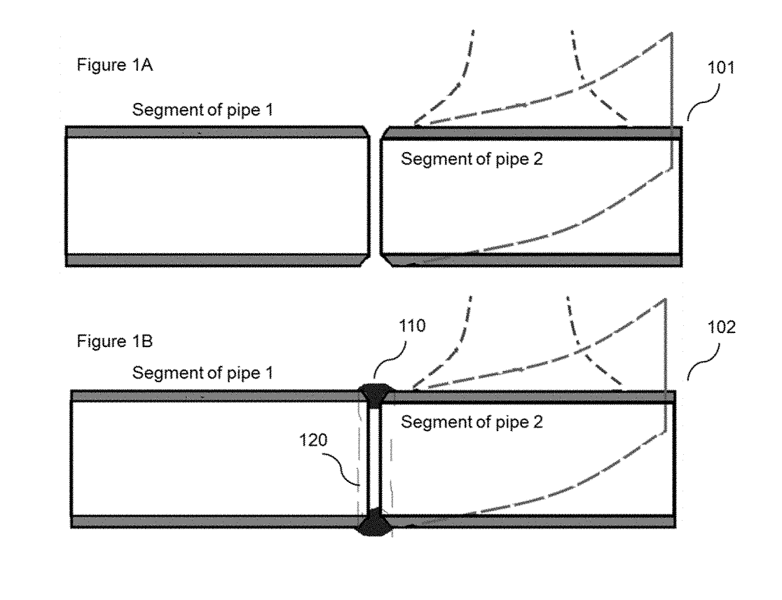

Piping failures associated with MIC may be more likely to occur near weld joints. Weld joints are formed when the abutting ends of two segments of pipe are joined by welding them together using a suitable welding process and weld material. FIG. 1B shows an illustrative example of two segments of pipe which are joined at weld joint 110. The properties of a weld joint and the nearby surface may determine the extent of biofilm formation and subsequent MIC. For example, the shape of the weld bead formed at a weld joint may influence the amount of bacteria that adheres to the surface of the piping and the severity of the resulting MIC.

The welding process (for example, the high temperatures used for welding) may also change the physical and chemical properties of the surface of the base metal near each weld joint in a so-called “heat affected zone.” The altered chemical and physical properties of the base metal of the piping may cause organic material to preferentially accumulate on surfaces in the heat affected zone. For example, FIG. 1B depicts heat affected zone 120, which is bounded by vertical dashed lines near weld joint 110. Organic material accumulated in heat affected zone 120 may increase the risk of bacterial adhesion on the surface and of MIC near each weld joint.

In general, a heat affected zone may be characterized by a surface oxide, an altered distribution of chemical components in the base metal (for example, caused by the segregation of components in the base metal), an altered microstructure of the base metal, or combinations of the three. The surface oxide that forms in a heat affected zone may result in a discoloration of the base metal, weld joint, or both. Such a discoloration is also called a heat tint. Standards for evaluating the extent of oxidation on a pipe's surface based on the characteristics of a heat tint are provided in AWS D18.2:1999, the entirety of which is incorporated in the present disclosure by reference. In addition to having an increased risk of MIC, the surface of a heat affected zone may also be more susceptible to other forms of corrosion, including chloride stress corrosion cracking.

Conventional methods to minimize physical and chemical changes to surfaces in the heat affected zone have a limited effectiveness. For example, the composition of a backing gas used for welding may be carefully selected and controlled in an attempt to reduce the formation of a surface oxide (for example, a heat tint) in the heat affected zone. However, such approaches often require very costly welding conditions that may be difficult to maintain, reproduce, or both in common welding environments. For example, the amount of surface oxide that forms during welding may also be influenced by the level of moisture in the backing gas (for example, increased moisture levels result in increased oxide formation), the presence of contaminants on the surface prior to welding (for example, the presence of hydrocarbons, moisture, or particulates influences the extent and characteristics of oxide formation), and the surface finish of the base metal of each segment of pipe being welded. Moreover, even if oxide formation is effectively prevented, the physical properties (for example, the microstructural properties) of the surface may still be altered in the heat affected zone, resulting in an increased risk of MIC, other forms of corrosion, or both. Alternative efforts to prevent bacterial adhesion and subsequent MIC in the heat affected zone such as polishing the heat affected zone and vibrating the piping during operation have also failed.

Accordingly, piping is needed with an improved resistance to bacterial adhesion and MIC particularly in the heat affected zone near each weld joint. The corrosion-resistant piping described in the present disclosure includes a corrosion-resistant cladding disposed on one or more weld joints of the piping. The corrosion-resistant cladding may provide an improved resistance to bacterial attachment and biofilm formation.

### Corrosion-Resistant Piping

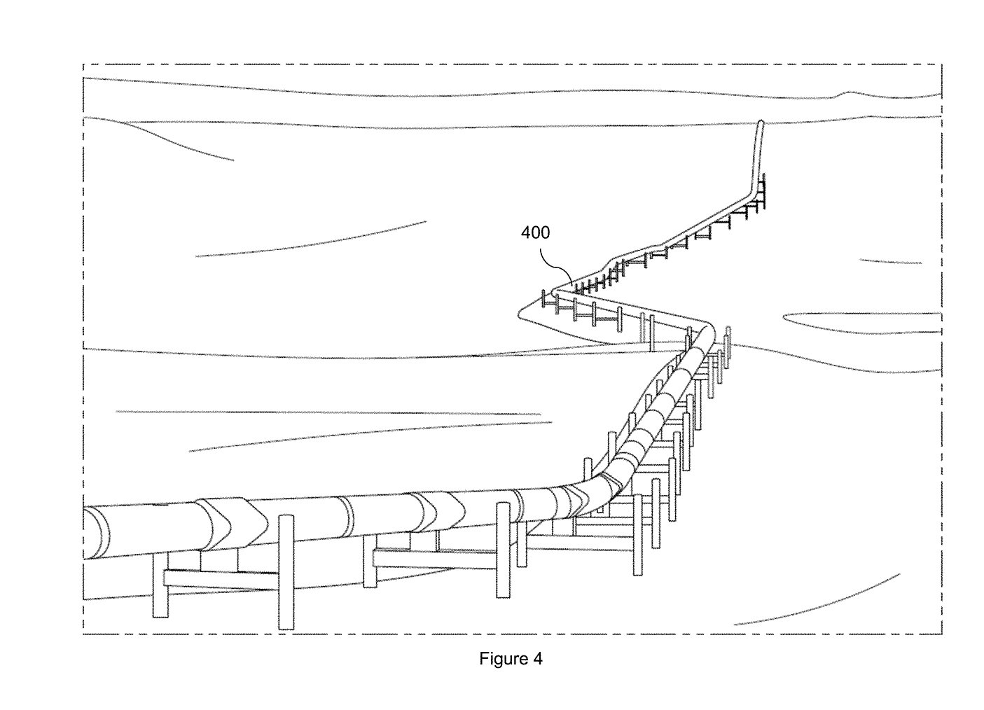

In some embodiments, corrosion-resistant piping may be a corrosion-resistant pipeline or other corrosion-resistant equipment, for example, used for the transportation of oil, natural gas, petrochemicals, water, wastewater, utilities, or the like. For example, corrosion-resistant piping may be used in the pulp and paper industry, in wastewater treatment plants, in power generation plants, in metalworking plants, in the chemical and petrochemical industries, or the like. For example, FIG. 4 shows an illustrative example of a corrosion-resistant pipeline 400.

Corrosion-resistant piping may include two or more segments of pipe, for example, such as segment of pipe 1 and segment of pipe 2 shown in illustrative example piping 101 of FIG. 1A. Each segment of pipe may have a composition that includes a stainless steel alloy. For example, each segment of pipe may be constructed from a stainless steel alloy. In some embodiments, the stainless steel alloy may be austenitic stainless steel or super austenitic stainless steel (for example, alloy 304/304L, alloy 316/316L, alloy 321/347, alloy 254SMo/S31254, or the like).

The corrosion-resistant piping may include one or more weld joints at which one segment of pipe is joined to another. The two joined segments of pipe may be connected by a girth weld (or circumferential weld), for example, using a weld material. FIG. 1B shows an illustrative example of piping 102 in which two segments of pipe are joined at weld joint 110. In some embodiments, the weld material may be a Ni alloy with a percentage of Ni by weight of 40% or greater (based on the total weight of the weld material). In some embodiments, the weld material may be alloy 625 or alloy 825.

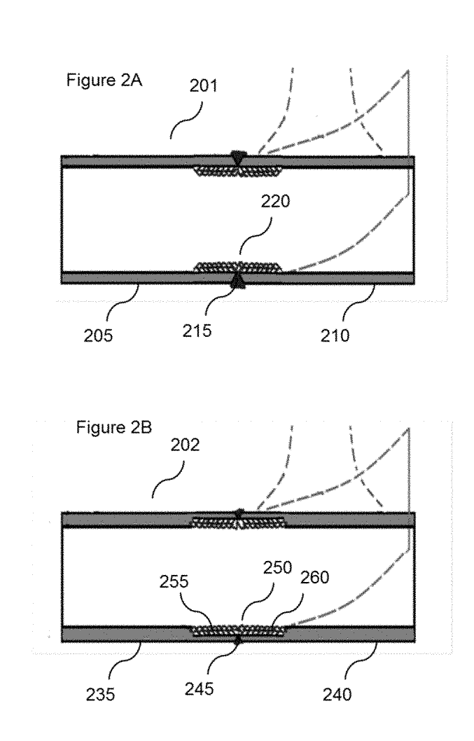

FIG. 2A depicts an illustrative example of corrosion-resistant piping 201. According to this illustrative example, corrosion-resistant piping 201 includes weld joint 215 at which segment of pipe 205 is joined to segment of pipe 210. As shown in the example of FIG. 2A, corrosion-resistant cladding 220 may be disposed on weld joint 215. Corrosion-resistant cladding 220 may include at least one layer with a composition that includes a corrosion-resistant alloy. For example, the corrosion-resistant cladding may include one to three layers that have a composition that includes a corrosion-resistant alloy. In some embodiments, the corrosion-resistant alloy may be a heat-treatable Ni alloy. For example, the corrosion-resistant alloy may have a percentage of Ni by weight of 40% or greater (based on the total weight of the corrosion-resistant alloy). For example, the corrosion-resistant alloy may be alloy 625 or super austenitic stainless steel (for example, alloy 254SMo/S31254). In some embodiments, the corrosion resistance of the corrosion-resistant alloy may be greater than the corrosion resistance of the stainless steel alloy (for example, the base metal of each segment of pipe). In some embodiments, the corrosion-resistant cladding may be 1 mm to 3.5 mm in thickness.

As shown in FIG. 2A, corrosion-resistant cladding 220 may extend in length along an internal surface area portion of each of the joined segments of pipe (205 and 210) adjacent to weld joint 215 from an outermost edge of weld joint 215 to at least a corrosion-susceptible length of pipe. In some embodiments, the corrosion-susceptible length of pipe may be in a range from 10 mm to 100 mm and less than a full length of the corresponding segment of pipe. In some embodiments, the corrosion-susceptible length of pipe may be in a range from 10 mm to 50 mm and less than the full length of a corresponding segment of pipe.

In some embodiments, an internal surface area portion of each of the joined segments of pipe may include a machined recess. FIG. 2B depicts an illustrative example of corrosion-resistant piping 202, which includes machined recess 255 and machined recess 260 in the surfaces of segments of pipe 235 and 240, respectively, according to an illustrative embodiment.

In the illustrative example of FIG. 2B, corrosion-resistant piping 202 includes weld joint 245 at which segment of pipe 235 is joined to segment of pipe 240. Corrosion-resistant cladding 250 may be disposed on weld joint 245. Corrosion-resistant cladding 250 may include at least one layer with a composition that includes a corrosion-resistant alloy. For example, corrosion-resistant cladding 250 may include one to three layers that have a composition that includes a corrosion-resistant alloy. In some embodiments, the corrosion-resistant alloy may be a heat-treatable Ni alloy. For example, the corrosion-resistant alloy may have a percentage of Ni by weight of 40% or greater (based on the total weight of the corrosion-resistant alloy). For example, the corrosion-resistant alloy may be alloy 625 or super austenitic stainless steel (for example, alloy 254SMo/S31254). In some embodiments, the corrosion resistance of the corrosion-resistant alloy may be greater than the corrosion resistance of the stainless steel alloy (for example, the base metal of each segment of pipe). In some embodiments, corrosion-resistant cladding 250 may be 1 mm to 3.5 mm in thickness.

As shown in FIG. 2B, corrosion-resistant cladding 250 may extend in length along an internal surface area portion of each of the joined segments of pipe 235 and 240 adjacent to weld joint 245 from an outermost edge of weld joint 245 to at least a corrosion-susceptible length of pipe. In some embodiments, the corrosion-susceptible length of pipe may be in a range from 10 mm to 100 mm and less than a full length of the corresponding segment of pipe. In some embodiments, the corrosion-susceptible length of pipe may be in a range from 10 mm to 50 mm and less than the full length of a corresponding segment of pipe.

As shown in the illustrative example of FIG. 2B, the location of machined recess 255 and machined recess 260 may correspond to the location of corrosion-resistant cladding 250. For example, machined recess 255 and machined recess 260 may reduce transitions in the internal diameter (ID) of corrosion-resistant piping 202 near weld joint 245. In some embodiments, the depth of the machined recess may be selected to comply with design codes, for example, as set forth in ASME B31.3, ASME B31.4, ASME B31.8, or the like. In some embodiments, the depth of a machined recess may be at least 1 mm. In some embodiments, the depth of a machined recess may be in a range from 1 mm to at least 3 mm.

In some embodiments, a surface of a corrosion-resistant cladding (for example, corrosion-resistant cladding 220 of FIG. 2A or corrosion-resistant cladding 250 of FIG. 2B) may be machined. For example, a surface of the corrosion-resistant cladding may be machined to reduce transitions in the internal diameter (ID) of the corrosion-resistant piping near each weld joint. In some embodiments, the corrosion-resistant cladding may be machined to comply with design codes, for example, as set forth in ASME B31.3, ASME B31.4, ASME B31.8, or the like. For example, an amount of material removed from the corrosion-resistant cladding during machining might be selected to satisfy criteria set forth in ASME B31.3, ASME B31.4, ASME B31.8, or the like.

In some embodiments, corrosion-resistant piping may also include at least one fitting. For example, corrosion-resistant piping may also include an elbow, a reducer, a tee, a valve, a flange, a bend, or the like. Example depictions of the shape of a tee fitting and a bend fitting are depicted by the dashed lines shown in FIG. 2A and FIG. 2B.

In some embodiments, the corrosion-resistant cladding may be a corrosion-resistant weld overlay. For example, when the geometry of a segment of pipe is irregular, a weld overlay may be used as a cladding. For example, a corrosion-resistant cladding may be applied using an arc surfacing or overlaying technology such as plasma surfacing. In some embodiments, a corrosion resistant weld overlay may cost less to manufacture than a cladding prepared with, for example, hot roll bonding or explosion bonding. It should be understood that a variety of other known cladding and weld overlay technologies may be used to apply a corrosion-resistant cladding.

### Method of Manufacturing Corrosion-Resistant Piping

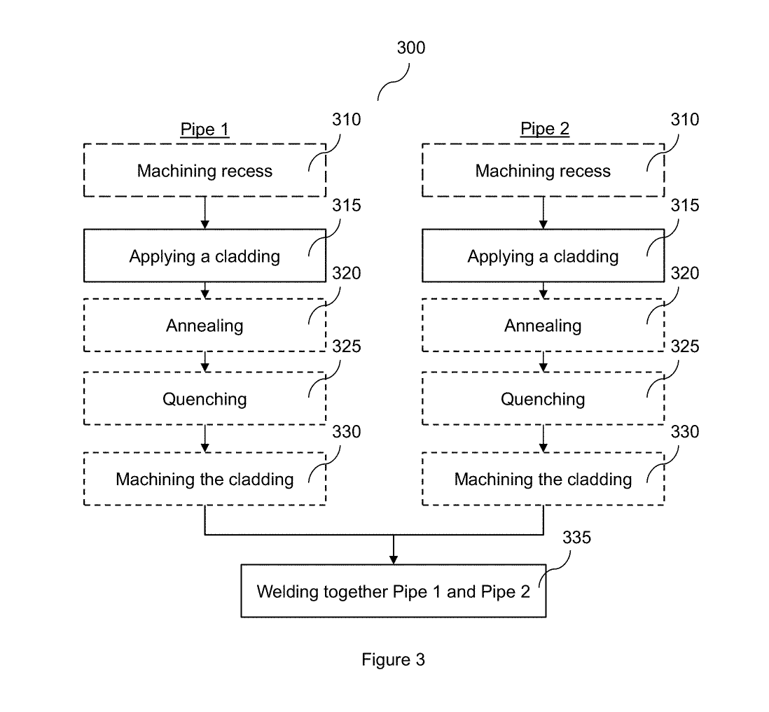

FIG. 3 shows an illustrative example of a method 300 for manufacturing corrosion-resistant piping from two segments of pipe (for example, Pipe 1 and Pipe 2 in the illustrative example of FIG. 3). Each segment of pipe may have a composition that includes a stainless steel alloy. In some embodiments, the stainless steel alloy may be austenitic stainless steel or super austenitic stainless steel (for example, alloy 304/304L, alloy 316/316L, alloy 321/347, alloy 254SMo/S31254, or the like).

Machining a Recess in Each Segment of Pipe

In some embodiments, a recess may, optionally, be machined in an internal surface area portion of each segment of pipe (for example, in Pipe 1 and Pipe 2 of FIG. 3) (Step 310). For example, an illustrative example of machined recess 255 in an internal surface area portion of segment of pipe 235 is depicted in FIG. 2B. As shown in the illustrative example of FIG. 2B, a recess may be machined in a location corresponding to the location of the corrosion-resistant cladding, which may be applied in Step 315 of example method 300 shown in FIG. 3. In some embodiments, machining a recess in an internal surface area portion of each segment of pipe may reduce transitions in the internal diameter (ID) of the corrosion-resistant piping near each weld joint. In some embodiments, the depth of the machined recess may be selected to comply with design codes, for example, as set forth in ASME B31.3, ASME B31.4, ASME B31.8, or the like. In some embodiments, the depth of a machined recess may be at least 1 mm. In some embodiments, the depth of a machined recess may be in a range from 1 mm to at least 3 mm.

Applying a Corrosion-Resistant Cladding

Referring still to FIG. 3, a corrosion-resistant cladding may be applied to two or more segments of pipe (for example, Pipe 1 and Pipe 2) in Step 315. For example, the corrosion-resistant cladding may include at least one layer with a composition that includes a corrosion-resistant alloy. For example, the corrosion-resistant cladding may include one to three layers that have a composition that includes a corrosion-resistant alloy. In some embodiments, the corrosion-resistant alloy may be a heat-treatable Ni alloy. For example, the corrosion-resistant alloy may have a percentage of Ni by weight of 40% or greater (based on the total weight of the corrosion-resistant alloy). For example, the corrosion-resistant alloy may be alloy 625 or super austenitic stainless steel (for example, 254SMo/S31254). In some embodiments, the corrosion resistance of the corrosion-resistant alloy may be greater than the corrosion resistance of the stainless steel alloy (that is, the base metal of each segment of pipe). In some embodiments, the corrosion-resistant cladding may be 1 mm to 3.5 mm in thickness.

As described previously with respect to FIG. 2A, a corrosion-resistant cladding may extend in length along an internal surface area portion of each of the segments of pipe adjacent to an end of each segment from an outermost edge of the end to at least a corrosion-susceptible length of pipe. In some embodiments, the corrosion-susceptible length of pipe may be in a range from 10 mm to 100 mm and less than a full length of a corresponding segment of pipe. In some embodiments, the corrosion-susceptible length of pipe may be in a range from 10 mm to 50 mm and less than a full length of a corresponding segment of pipe.

When a recess is machined in each segment of pipe in Step 310, the corrosion-resistant cladding may be applied (Step 315) in a location corresponding to the location of the machined recess. In some embodiments, applying a corrosion-resistant cladding to a machined recess may reduce transitions in the internal diameter (ID) of the corrosion-resistant piping near each weld joint. In some embodiments, the depth of the machined recess may be selected such that the corrosion-resistant piping complies with design codes, for example, as set forth in ASME B31.3, ASME B31.4, ASME B31.8, or the like.

In some embodiments, the corrosion-resistant cladding may be applied in Step 315 before the two or more segments of pipe are manufactured. For example, the corrosion-resistant cladding may be applied when each segment of pipe is in the “plate stage, or before each segment of pipe has been rolled to form a pipe. Alternatively, in some embodiments, the corrosion-resistant cladding may be applied after the two or more segments of pipe are manufactured. For example, the corrosion-resistant cladding may be applied using arc surfacing or overlaying technology such as plasma surfacing. For example, the corrosion-resistant cladding may be applied using a cladding technology such as hot roll bonding or explosion bonding. As described previously, it should be understood that a variety of other known cladding and weld overlay technologies may be used to apply the corrosion-resistant cladding described in the present disclosure.

In some embodiments, corrosion-resistant piping may also include at least one fitting. For example, Pipe 1, Pipe 2, or both shown in the illustrative example of FIG. 3 may be a fitting. In some embodiments, the fitting may by an elbow, a tee, a reducer, a valve, a flange, a bend, or the like. Example depictions of the shape of a tee fitting and a bend fitting are depicted by the dashed lines in FIG. 2A.

Post-Cladding Solution Annealing

In some embodiments, the two or more segments of pipe may be heat treated (or annealed) (Step 320) and rapidly cooled (or quenched) (Step 325). Annealing and quenching may, for example, improve the microstructure of the internal surface area portion of each segment of pipe in the heat affected zone (for example, near each weld joint). For example, two or more segments of pipe may be solution annealed after a corrosion-resistant cladding is applied in Step 315. For example, two or more segments of pipe may be annealed (Step 320) and quenched (Step 325) according to ASTM A480. For example, the two or more segments of pipe may be heated at a temperature of approximately 1040° C. (Step 320) or greater for about 30 min, 1 hour, 4 hour, or another appropriate interval of time.

In step 325 shown in the illustrative example of FIG. 3, the heated segments of pipe may be rapidly cooled in an appropriate fluid. For example, the two or more segments of pipe may be cooled in water (for example, with or without salts, chemical additives, or both), oil, or air. The segments of pipe may, for example, be cooled at a sufficiently rapid rate to prevent the reprecipitation of carbides or other undesirable byproducts in the stainless steel alloy. For example, the two or more segments of pipe may be cooled per relevant ASTM/ASME product standards.

In some embodiments, heating (Step 320) and rapidly cooling (Step 325) the two or more segments of pipe, improves the corrosion resistance of the corrosion-resistant cladding. As described previously, the corrosion-resistant alloy may be a heat treatable alloy (for example, alloy 625). The corrosion resistance of a heat treatable alloy may, for example, be improved after solution annealing (for example, heating in Step 320 and rapidly cooling in Step 325).

In some embodiments, the two or more segments of pipe are not solution annealed (for example, heated and rapidly cooled) before a corrosion-resistant cladding is applied in Step 315. Delaying solution annealing of a segment of pipe until after the application of a corrosion-resistant cladding may, for example, improve the corrosion resistance of the segment. For example, following a post-cladding solution annealing step (for example, Step 320 and Step 325), the corrosion resistance of a stainless steel alloy that was not previously solution annealed may be improved to a greater extent than that of a stainless steel alloy that was previously solution annealed. Accordingly, in some embodiments, solution annealing each segment of pipe after the application of a corrosion-resistant cladding may prevent (or reduce) MIC. In some embodiments, subsequent steps such as pickling and passivation may be performed to further improve the properties of the corrosion-resistant cladding, the stainless steel alloy, other materials used to construct the piping, or combinations of the three.

Machining Surface of Cladding

Referring still to FIG. 3, in some embodiments, a surface of the corrosion-resistant cladding may be machined in Step 330. For example, the surface of the corrosion-resistant cladding may be machined in Step 330 to reduce transitions in the internal diameter (ID) of the corrosion-resistant piping near each weld joint. For example, the corrosion-resistant cladding may be machined in Step 330 to comply with design codes, for example, as set forth in ASME B31.3, ASME B31.4, ASME B31.8, or the like. For example, an amount of material removed from the corrosion-resistant cladding during machining may be selected to satisfy criteria set forth in ASME B31.3, ASME B31.4, ASME B31.8, or the like.

Joining the Two or More Segments

As shown in the illustrative example of FIG. 3, the two or more segments of pipe (Pipe 1 and Pipe 2) may be joined by welding the two segments together (Step 335). For example, the segments may be welded together using a weld material. For example, two adjacent segments of pipe may be joined by a girth weld (or circumferential weld). An illustrative example of two joined segments of pipe is shown in FIG. 1B, which includes weld joint 110. In some embodiments, the weld material may be a Ni alloy with a percentage of Ni by weight of 40% or greater (based on the total weight of the weld material). In some embodiments, the weld material may be alloy 625 or alloy 825. In some embodiments, the weld material may be selected to be compatible with both the base metal of the segment of pipe (for example, a stainless steel alloy) and the corrosion-resistant alloy of the corrosion-resistant cladding.

### Use of Corrosion-Resistant Piping

The corrosion-resistant piping described in the present disclosure may be used by conducting a fluid through the two or more segments of pipe. In some embodiments, fluid(s) conducted through corrosion-resistant piping may include water, gas, petrochemical(s), wastewater, combinations of the same, or the like. For example, the fluid may include corrosive substances such as H₂S, CO₂, chloride ions, or the like. For example, the fluid may have a low pH (for example, a pH of less than 4.5).

In some embodiments, the corrosion-resistant piping may satisfy standard operating or design criteria after a fluid is conducted through the corrosion-resistant piping for at least one month. For example, failure resulting from MIC (or other corrosion mechanisms) may not be observed in the corrosion-resistant piping after operation for at least one month. For example, failure resulting from MIC (or other corrosion mechanisms) might not be observed for 2 months, 3 months, 6 months, 1 year, 2 years, or longer. For example, in some embodiments, following at least one month of conducting a fluid through the corrosion-resistant piping, the corrosion-resistant piping may satisfy the criteria set forth by the American Welding Society (AWS) in AWS D18.1/D18.1M:2009. For example, in some embodiments, following at least one month of conducting a fluid through the corrosion-resistant piping, a color of a surface oxide (for example a heat tint associated with an oxide layer such as a chromium oxide layer) on a surface of the corrosion-resistant cladding may satisfy criteria set forth by the American Welding Society in AWS D18.2:1999. In certain embodiments, the corrosion-resistant piping satisfies such criteria for longer intervals of time, for example, 2 months, 3 months, 6 months, 1 year, 2 years, or longer.

### Selected Design Codes and Industry Standards

The American Society of Mechanical Engineers (ASME) publishes codes related to, for example, the design, preparation, and operation of piping for a range of applications including those relevant to the present disclosure.

ASME B31.3, the entirety of which is incorporated in the present disclosure by reference, sets forth, for example, requirements for piping typically found in petroleum refineries; chemical, pharmaceutical, textile, paper, semiconductor, and cryogenic plants; and related processing plants and terminals.

ASME B31.4, the entirety of which is incorporated in the present disclosure by reference, sets forth, for example, requirements for the design, materials, construction, assembly, inspection, testing, operation, and maintenance of liquid pipeline systems between production fields or facilities, tank farms, above- or below ground storage facilities, natural gas processing plants, refineries, pump stations, ammonia plants, terminals (marine, rail, and truck), and other delivery and receiving points, as well as pipelines transporting liquids within pump stations, tank farms, and terminals associated with liquid pipeline systems).

ASME B31.8, the entirety of which is incorporated in the present disclosure by reference, sets forth, for example, requirements for the design, fabrication, installation, inspection, testing, and other safety aspects of operation and maintenance of gas transmission and distribution systems, including gas pipelines, gas compressor stations, gas metering and regulation stations, gas mains, and service lines up to the outlet of the customer's meter set assembly.

ASME Boiler and Pressure Vessel Code Section II Part A, the entirety of which is incorporated in the present disclosure by reference, sets forth, for example, rules of safety related to the design, fabrication, and inspection of boilers and pressure vessels.

Similarly, the American Welding Society publishes standards for welding of stainless steel equipment.

AWS D18.1/D18.1M:2009, the entirety of which is incorporated in the present disclosure by reference, sets forth, for example, specifications for welding austenitic stainless steel tube and pipe systems in sanitary (hygienic) applications.

AWS D18.2:1999, the entirety of which is incorporated in the present disclosure by reference, sets forth, for example, a guide to weld discoloration on the inside of austenitic stainless steel tube.

ASTM International also publishes standards relevant to the corrosion-resistant piping described in the present disclosure.

ASTM A480, the entirety of which is incorporated in the present disclosure by reference, sets forth, for example, requirements for flat-rolled stainless and heat-resisting steel plate, sheet, and strip.

Elements of different implementations described in the present disclosure may be combined to form other implementations not specifically set forth above. For example, elements may be left out of the methods described in the present disclosure without adversely affecting their operation. In addition, the logic flows depicted in the figures do not necessarily require the particular order shown, or sequential order, to achieve desirable results. In some embodiments, various separate elements may be combined into one or more individual elements to perform the functions described.

While the corrosion-resistant piping and associated methods have been particularly shown and described with reference to specific preferred embodiments, it should be understood by those skilled in the art that various changes in form and detail may be made without departing from the spirit and scope of the present disclosure, as defined by the appended claims.

1. Corrosion-resistant piping comprising two or more segments of pipe, each of said segments having a composition comprising a stainless steel alloy, wherein:
(i) the piping comprises one or more weld joints at which one segment of pipe is joined to another;
(ii) at least one of the one or more weld joints has disposed thereon a corrosion-resistant cladding, the corrosion-resistant cladding comprising at least one layer having a composition comprising a corrosion-resistant alloy; and
(iii) for each of the one or more weld joints, the corrosion-resistant cladding extends in length along an internal surface area portion of each of the joined segments of pipe adjacent to the weld joint from an outermost edge of the weld joint to at least a corrosion-susceptible length of pipe, wherein said corrosion-susceptible length of pipe is from 10 mm to 100 mm and less than a full length of a corresponding segment of pipe.

2. The corrosion-resistant piping of claim 1, wherein the stainless steel alloy is austenitic stainless steel or super austenitic stainless steel.

3. The corrosion-resistant piping of claim 1, wherein the corrosion-resistant cladding comprises one to three layers having a composition comprising the corrosion-resistant alloy.

4. The corrosion-resistant piping of claim 1, wherein the corrosion-resistant cladding is 1 mm to 3.5 mm in thickness.

5. The corrosion-resistant piping of claim 1, wherein the corrosion-resistant alloy is a Ni alloy or super austenitic stainless steel.

6. The corrosion-resistant piping of claim 1, wherein one segment of pipe is joined to another with a weld material.

7. The corrosion-resistant piping of claim 1, wherein the internal surface area portion of each of the joined pipe segments comprises a machined recess.

8. The corrosion-resistant piping of claim 1, wherein a surface of the corrosion-resistant cladding is machined.

9. The corrosion-resistant piping of claim 1, further comprising at least one fitting.

10. The corrosion-resistant piping of claim 1, wherein the corrosion-resistant alloy is heat treatable.

11. A method for manufacturing corrosion-resistant piping comprising two or more segments of pipe, each of said segments having a composition comprising a stainless steel alloy, the method comprising:
applying a corrosion-resistant cladding to two or more segments of pipe, each of said segments having a composition comprising a stainless steel alloy, wherein
(i) the corrosion-resistant cladding comprises at least one layer having a composition comprising a corrosion-resistant alloy,
(ii) the corrosion-resistant cladding extends in length along an internal surface area portion of each of the segments of pipe adjacent to an end of each segment from an outermost edge of the end to at least a corrosion-susceptible length of pipe, wherein said corrosion-susceptible length of pipe is from 10 mm to 100 mm and less than a full length of a corresponding segment of pipe; and
joining the two or more segments of pipe using a weld material, wherein at least one outermost edge of an end of each of the two or more segments of pipe is joined to an outermost edge of an end of an adjacent segment of pipe, thereby forming a weld joint.

12. The method of claim 11, wherein the two or more segments of pipe are not solution annealed prior to the step of applying a cladding.

13. The method of claim 11, comprising, after applying the corrosion-resistant cladding,
heating the two or more segments of pipe; and
rapidly cooling the two or more segments of pipe in a fluid.

14. (canceled)

15. (canceled)

16. (canceled)

17. (canceled)

18. (canceled)

19. The method of claim 11, comprising, prior to applying the corrosion-resistant cladding:
machining a recess in the internal surface area portion of each segment of pipe; and
applying the corrosion-resistant cladding to one or more of the machined recesses.

20. The method of claim 11, wherein the step of applying the corrosion-resistant cladding is performed before the two or more segments of pipe are manufactured.

21. The method of claim 11, wherein the step of applying the corrosion-resistant cladding is performed after the two or more segments of pipe are manufactured.

22. The method of claim 11, comprising, following applying the corrosion-resistant alloy, machining a surface of the corrosion-resistant cladding.

23. (canceled)

24. (canceled)

25. A method of using the corrosion-resistant piping of claim 1, the method comprising conducting a fluid through the two or more segments of pipe for at least one month.

26. The method of claim 25, wherein, following the at least one month, the corrosion-resistant piping satisfies criteria set forth by the American Welding Society (AWS) in AWS D18.1/D18.1M:2009.

27. The method of claim 25, wherein, following the at least one month, a color of a surface oxide on a surface of the corrosion-resistant cladding satisfies criteria set forth by the American Welding Society in AWS D18.2:1999.
